(19) United States
(12) Patent Application Publication
(10) Pub. No.: US 2026/0358223 A1
(43) Pub. Date: Nov. 12, 2026

(54) TEMPERATURE SENSOR, MICROWAVE SENSOR AND MAGNETIC-INDUCTIVE FLOW METER

(71) Applicant: Endress+Hauser Flowtec AG, Reinach (CH)

(72) Inventors: Frank Voigt, Weil am Rhein (DE); Pierre-Jean Ober, Hagenthal-le-bas (FR); Stefan Pflüger, München (DE)

(21) Appl. No.: 19/487,161

(22) PCT Filed: May 24, 2024
(86) PCT No.: PCT/EP2024/064355

§ 371 Date: Nov. 24, 2025

(30) Foreign Application Priority Data
May 23, 2023 (DE) 10 2023 113 838.3

(51) Int. Cl. G01N 15/06; G01F 1/58; G01F 1/74; G01K 1/02; G01K 1/08; G01K 1/14; G01K 13/02; G01K 15/00; G01N 15/00

(52) U.S. Cl. CPC G01N 15/06; G01F 1/584; G01F 1/74; G01K 1/026; G01K 1/08; G01K 1/14; G01K 13/026; G01K 15/005; G01N 2015/0053

(57) ABSTRACT

A temperature sensor for ascertaining a temperature of a measurement material includes a probe body, the probe body comprising: a measuring tip configured to be brought into contact with the measurement material; a first probe receptacle extending into a front portion of the measuring tip; a second probe receptacle located only in an end portion of the probe body; a first temperature probe arranged in the first probe receptacle and configured to determine a first measurement value, wherein the first measurement value predominantly reflects a current temperature of the front portion; and a second temperature probe arranged in the second probe receptacle and configured to determine a second measurement value, wherein the second measurement value predominantly reflects a current temperature of the end portion. The present disclosure further relates to a microwave sensor and to a magnetic-inductive flow meter.

The invention relates to a temperature sensor for ascertaining a temperature of a measurement material, to a microwave sensor for determining a solid content δ of a solid in a flowable, in particular aqueous, measurement material, and to a magnetic-inductive flow meter for ascertaining a flow-rate-dependent measurement variable of a flowable, in particular conductive, measurement material.

It is possible, by means of microwaves, to determine the physical variables of permittivity and loss factor of a medium in a process line. From these two variables—measured either at one or over many different frequencies—it is possible to draw conclusions regarding application-specific parameters, for example the proportion of water in a mixture of water and other non-polar or weakly polar components or a solid content in a liquid medium.

The established transmission/reflection measurement is described in L. F. Chen, C. K. Ong, C. P. Neo, V. V. Varadan, V. K. Varadan—“Microwave Electronics, Measurement and Materials Characterization”, John Wiley & Sons Ltd., 2004. For this purpose, the microwave signal interfaces at two different positions at the medium in a container or measuring tube, the scatter parameters (transmission and optionally reflection) are measured between these interface structures, and the mentioned physical properties of the medium are calculated from the measured scatter parameters.

WO 2018 121927 A1 teaches a measuring assembly for analyzing properties of a flowing medium by means of microwaves. In addition to the microwave antennas, the measuring assembly has an electrically insulating lining layer on the inner peripheral surface of the measuring tube. This lining layer forms a dielectric waveguide via which at least part of the one microwave signal can travel from a first microwave antenna to a second microwave antenna. One application for such a measuring assembly is the determination of solid contents in the liquid medium being conveyed. WO 2021/099152 A1 teaches a microwave antenna which has a front portion in contact with the measurement material, via which the excitation signal is emitted into the medium. To ascertain the solid content, complex models are necessary that depend on the actual temperature of the measurement material. This requires accurate temperature measurement.

Magnetic-inductive flow meters are used for determining the flow rate and the volumetric flow of a flowing medium in a pipe. A magnetic-inductive flow meter has a magnetic-field-generating device that generates a magnetic field perpendicular to the flow direction of the flowing medium. Single coils are typically used for this purpose. In order to realize a predominantly homogeneous magnetic field, pole shoes are additionally formed and attached such that the magnetic field lines run over the entire tube cross section substantially perpendicularly to the transverse axis or in parallel to the vertical axis of the measuring tube. In addition, a magnetic-inductive flow meter has a measuring tube on which the magnetic-field-generating device is arranged. A measurement electrode pair, which is attached to the peripheral surface of the measuring tube or arranged within the electrode openings in the measuring tube, taps an electrical measurement voltage or potential difference which is applied perpendicularly to the flow direction and to the magnetic field and occurs when a conductive medium flows through the applied magnetic field in the flow direction. Since, according to Faraday's law of induction, the tapped measurement voltage depends on the velocity of the flowing medium, the flow rate and -with the inclusion of a known tube cross section-the volumetric flow can be ascertained from the measured induced measurement voltage.

Magnetic-inductive flow meters are often used in process and automation engineering for fluids, starting from an electrical conductivity of approximately 5 μS/cm. Corresponding flow meters are sold by the applicant in a wide variety of embodiments for various fields of application-for example, under the name PROMAG. For special applications, information regarding the temperature of the measurement material and/or the conductivity, which is strongly temperature dependent, is desired in addition to the volume flow.

DE102012109308A1 describes a fill level monitoring system for a magnetic-inductive flow meter with an electrode for monitoring the fill level of a flowing medium in a tube, which electrode has an integrated temperature sensor. The disadvantage of this solution is the thermal coupling of the electrode with the interior of the housing, which can lead to a distortion of the temperature measurement.

The object of the invention is to provide an improved temperature determination.

The object is achieved by the temperature sensor, the microwave sensor and the magnetic-inductive flow meter.

The temperature sensor according to the invention for ascertaining a temperature of a measurement material, comprising:
comprises an, in particular metal, probe body:
   an, in particular at least partially conical measuring tip extending into a front portion of the 1 measuring tip;
   a second probe receptacle of the probe body is located,
a first temperature probe is arranged and is designed to determine a first measurement value,
   wherein in the first measurement value a contribution by a current temperature of the front portion predominates; and
a second temperature probe is arranged and is designed to determine a second measurement value,
   wherein in the second measurement value a contribution by a current temperature of the end portion predominates.

Advantageous embodiments of the invention are the subject matter of the dependent claims.

One embodiment provides for the temperature sensor, in particular the probe body, to further comprise:
a sealing means receptacle for receiving a sealing means positioned between the front portion and end portion,
   wherein the second probe receptacle extends not further than to the sealing means receptacle.

One embodiment provides for the first probe receptacle and/or the second probe receptacle to be at least partially connected to a thermal paste with four pins via an electrical conductor each,
wherein two further pins are electrically connected to the second temperature probe via an electrical conductor each.

One embodiment provides for the temperature probe, in particular the probe body, to further comprise:
a contact surface is positioned between the front portion and end portion,
   wherein the second probe receptacle extends not further than to the contact surface.

The microwave sensor according to the invention for determining a solid content δ of a solid in a flowable, in particular aqueous, measurement material, comprising:
a measuring tube for conducting the measurement material;
a transmitting antenna for generating a microwave signal passing through the measurement material;
a receiving antenna for receiving the microwave signal passing through the measurement material;
   a housing predominates;
   an evaluation electronics further designed to ascertain the solid content δ as a function of the first measurement value and the second measurement value.

One embodiment provides for the first temperature probe and the second temperature probe to be part of the temperature sensor according to the invention.

One embodiment provides for the evaluation electronics to be designed to ascertain a compensated temperature of the measurement material as a function of the first measurement value and the second measurement value.

The magnetic-inductive flow meter according to the invention for ascertaining a flow-rate-dependent measurement variable of a flowable, in particular conductive, measurement material, comprising:
a measuring tube for conducting the measurement material;
a housing for ascertaining a measurement voltage induced in the measurement material;
a magnetic field-generating device for generating a magnetic field passing through the measuring tube;
the temperature sensor according to the invention arranged at least partially in the magnetic field-generating device.

One embodiment provides for the temperature sensor to be designed as a measurement electrode, fill level monitoring electrode or reference electrode.

The invention is explained in greater detail with reference to the following figures, in which:

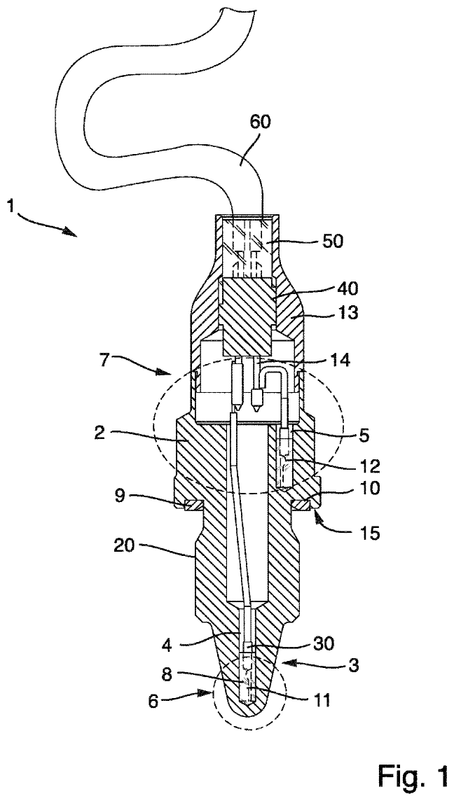

FIG. 1 shows a longitudinal section through a temperature sensor according to the invention;

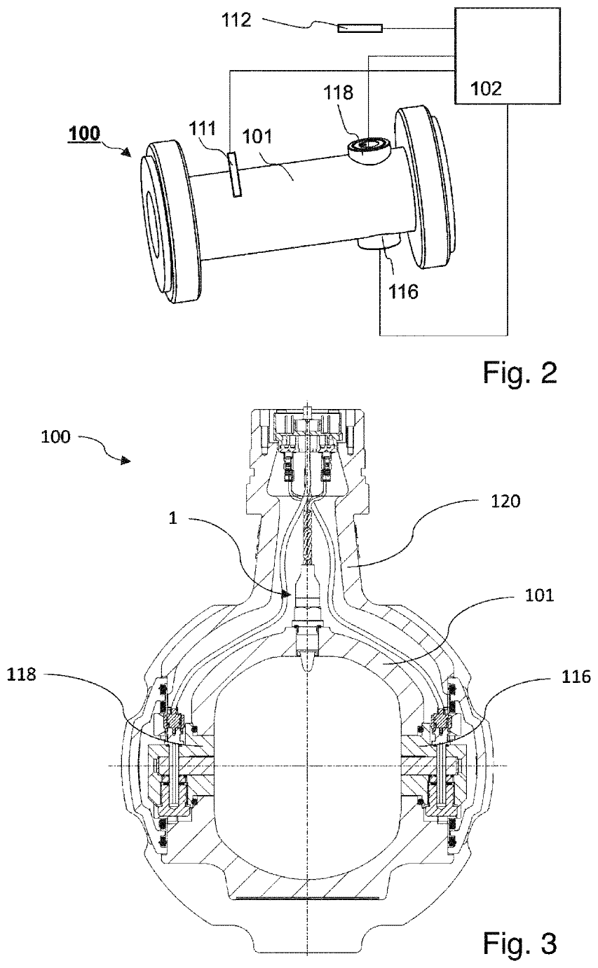

FIG. 2 shows a perspective view of a microwave sensor according to the invention;

FIG. 3 shows a cross section through another embodiment of the microwave sensor according to the invention; and

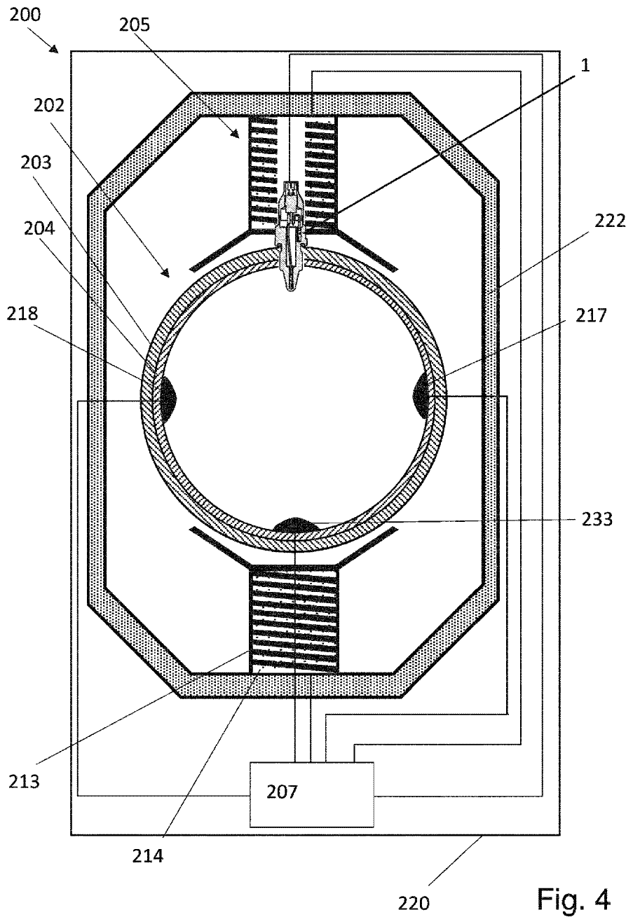

FIG. 4 shows a cross section through a magnetic-inductive flow meter according to the invention.

FIG. 1 shows a longitudinal section through a temperature sensor 1 according to the invention for ascertaining a temperature of a measurement material. The sensor 1 comprises a probe body 2 which can be made of metal. The probe body 2 is preferably made of a material which has good thermal conductivity, i.e., >1 W/(mK). A suitable material would be steel, for example. The probe body 2 shown is rotationally symmetrical at least in portions, i.e., in the front portion.

In the embodiment shown, the probe body 2 has a measuring tip 3 which is partially conical. Alternatively, the measuring tip 3 can also take on a different shape, such as a cylindrical shape. The measuring tip 3 is designed to be brought into contact with the measurement material to be monitored. Especially for applications with solid content in the measurement material, it is important to have a stable measuring tip 3 and yet good thermal contact between the measurement material and the temperature probe. For this purpose, the solution shown has a minimum thickness of 0.5 millimeters, in particular of at least 1 millimeter and at most 10 millimeters.

The probe body 2 has a first probe receptacle 4 which extends into a front portion 6 of the measuring tip 3. When the temperature sensor 1 is used, the front portion 6 is in contact with the measurement material and encompasses the center of the measuring tip 3 to which the probe body 2 shown tapers.

A first temperature probe 11 is arranged in the first probe receptacle 4. The temperature probe 11 can be a resistance thermometer (PT100 or PT1000) or a thermocouple. The first temperature probe 11 is designed to determine and provide a first measurement value. The first measurement value is a current temperature at the temperature probe or a value proportional thereto (e.g., electrical resistance). The ascertained current temperature is composed of several contributions. The first temperature probe 11 is positioned in such a way that the contribution by a current temperature of the front portion and thus—when using the temperature sensor—of the measurement material, which is in thermal contact with the front portion, on the first measurement value predominates.

The probe body 2 further comprises a second probe receptacle 5, which is located exclusively in an end portion 7 of the probe body 2. The end portion 7 does not come into contact with the measurement material and, when the temperature sensor 1 is installed on a container or a pipe, is located outside the part of the container or pipe in which the measurement material is located. This means that the second probe receptacle 5 is spaced from the first probe receptacle 4 in the longitudinal direction of the probe body 2. While the longitudinal axis of the probe body 2 runs through the first probe receptacle 4, the second probe receptacle 6 is arranged offset from the longitudinal axis of the probe body 2 in the radial direction.

A second temperature probe 12 is arranged in the second probe receptacle 5 and designed to determine a second measurement value. The second measurement value is also a current temperature at the temperature probe or a value proportional thereto (e.g., electrical resistance). It also consists of several contributions. The contribution by a current temperature of the end portion 7 predominates.

The second measurement value can be used to correct the temperature of the measurement material ascertained based on the first measurement value. Especially when the ambient temperature of the measuring point differs from the temperature of the medium, the ascertained temperature value differs from the actual temperature of the measurement material.

If the ambient temperature and thus also the temperature to which the second temperature probe 12 is exposed is significantly lower than the temperature of the measurement material, the temperature value ascertained with the first temperature probe 11 is also significantly lower than the actual temperature of the measurement material.

If the ambient temperature and thus also the temperature to which the second temperature probe 12 is exposed is significantly higher than the temperature of the measurement material, the temperature value ascertained with the first temperature probe 11 is also significantly higher than the actual temperature of the measurement material.

This is because the first temperature probe 11 is not completely thermally decoupled from the environment. Using the second temperature probe 12 thus has the advantage that the influences of the ambient temperature leading to the erroneous measurement can be measured and the temperature value ascertained with the first temperature probe 11 can be corrected by the ascertained influence.

The cases mentioned above are static cases. However, using a second temperature probe 12 also has an advantage in a dynamic case. If the temperature of the measurement material changes, this is measured by the first temperature probe 11 in the front portion. The heat capacity of the environment has not yet reached the temperature of the measurement material and thus slightly influences the measurement value of the first temperature probe 11. This leads to a measurement error. The second temperature probe 12 in the end portion also measures inaccurately due to the temperature change. However, this is more delayed compared to the measurement with the first temperature probe due to lower thermal coupling with the measurement material. As the temperature rises, a difference between the measurement values measured at the two temperature probes occurs. The resulting difference can be used for correction purposes.

The temperature sensor 1 shown or the probe body 2 has a sealing means receptacle 10 for receiving a sealing means 9. In the embodiment shown, the sealing means 9 is a sealing ring. However, other sealing means—such as a sealing fluid applied in liquid form—are also suitable. Standardized seals specifically designed for the intended application are suitable as sealing means 9. The sealing means receptacle 10 is positioned between the front portion 6 and end portion 7. When in use, the sealing means 9 comes into contact with the wall of the container or pipe into which the temperature sensor 1 is inserted. In order to be able to detect the influence of the environment on the temperature measurement, it is important for the two temperature probes to be as far apart as possible or for the second temperature probe to be as far away from the measuring tip as possible. In the embodiment shown, the second probe receptacle 5 extends not further than to the sealing means receptacle 10. The sealing means receptacle 10 itself is designed as a groove that extends in the circumferential direction around the probe body 2.

In order to achieve optimal thermal coupling between the temperature probes 11, 12 and the respective portion to be monitored, the first probe receptacle 4 and the second probe receptacle 5 are at least partially filled with a thermal paste 8, in particular a silicone paste.

The probe body 2 is provided with a protective cap 13 that covers the interior of the probe body 2. The protective cap 2 has four pins 14 (only 2 pins are shown due to the perspective). Two pins are electrically connected to the first temperature probe 11 via an electrical conductor each, and the other two pins are electrically connected to the second temperature probe 12 via an electrical conductor each. The protective cap 13 is integrally connected to the probe body 2 in the end portion 7. This can be done, for example, by means of a welding method. Alternatively, the connection between the protective cap 13 and probe body 2 can also be realized by a form-fit and/or force-fit connection.

In the embodiment shown or in embodiments in which a sealing means is explicitly omitted, the temperature sensor 1 or the probe body 2 has a contact surface 15 which is designed to serve as a stop. If the probe body 2 is made of a metal and the container or the pipe is also metallic, a sufficient seal can be realized even without a sealing means by choosing a suitable (e.g., conical) contact surface 15. In such case, the contact surface 15 is positioned between the front portion 6 and end portion 7 and the second probe receptacle 5 extends not further than to the contact surface 15.

The illustrated embodiment of the probe body 2 has an external thread 20 with which the temperature sensor 1 can be screwed into an opening with an internal thread. The probe body further has a hexagonal portion which is part of the end portion 7.

The two electrical connectors, which connect the respective temperature probes to the pins, each have a ceramic sleeve 30 which prevents them from coming into contact with the thermal paste 8.

The protective cap 13 has an electrical insulator 40 in which the four pins are arranged. A front portion of the respective pins is located in a chamber formed by the protective cap 13 and the probe body 2. An end portion of the respective pins points away from the probe body 2. The pins 14 are connected to an evaluation electronics via the end portions by means of electrical conductors (e.g., twisted cables), so that an electrical connection is realized between the two temperature probes 11, 12 and the evaluation electronics. The four pins 14 are potted with an electrically insulating potting compound 50. It serves to provide strain relief for the electrical conductor relative to the wires that contact the two temperature probes.

FIG. 2 shows a perspective view of a microwave sensor 100 according to the invention. The microwave sensor 100 serves to determine a solid content δ of a solid in a flowable, in particular aqueous, measurement material. In the application of the microwave sensor 100, the measurement material is conducted in a process line through a measuring tube 101.

The illustrated microwave sensor 100 itself comprises a transmitting antenna 116 for generating a microwave signal passing through the medium when a measurement material is present in the measuring tube 101. The transmitting antenna 116 is arranged in an opening of the measuring tube 101. A suitable transmitting antenna 116 is disclosed in patent specification DE 10 2020 134 320 A1 , which are incorporated herein by reference in their entirety.

The microwave sensor 100 further comprises a receiving antenna 118 for receiving the microwave signal generated by the transmitting antenna 116 and passing through the medium when a medium is present in the measuring tube 101. A suitable receiving antenna 118 is also disclosed in patent specification DE 10 2020 134 320 A1 , which is incorporated herein by reference in its entirety.

Alternatively, the microwave sensor 100 can have only one antenna, which is a receiving antenna 118 and at the same time also a transmitting antenna 116. In such case, the microwave signal is generated by the antenna and also measured. For this purpose, the microwave signal is reflected at least once on an inner peripheral surface of the measuring tube back in the direction of the transmitting antenna.

The electronic components for connecting the receiving antenna 118 and the transmitting antenna to the evaluation electronics 102 are usually protected from external influences by a housing (not shown).

The microwave sensor 100 also has a first temperature probe 111, which is designed to determine a first measurement value and to provide it to the evaluation electronics. The first temperature probe 111 is positioned on or in the measuring tube 101 in such a way that thermal coupling between the measurement material and the first temperature probe 111 is realized. As a result, the contribution resulting from the current temperature of the measurement material predominates in the first measurement value.

According to the invention, the microwave sensor 100 has a further, second temperature probe 112, which is designed to determine a second measurement value. The second temperature probe 112 is arranged significantly away from the measuring tube 101, so that the predominant contribution to the second measurement value is caused by a current temperature in the housing. An evaluation electronics 102, which can also be arranged in the housing or in an external transmitter housing, is designed to ascertain the solid content δ as a function of a provided propagation time and/or absorption of the received microwave signal. In order to ascertain the solid content δ as accurately as possible, the temperature dependence of the permittivity of water must be taken into account when ascertaining it. For this purpose, the evaluation electronics 102 is designed according to the invention to ascertain the solid content δ as a function of the first measurement value and the second measurement value.

The compensated temperature of the measurement material can be relevant not only for increasing measurement accuracy of the solid content, but can also be shown to the customer, for example on a display. For this purpose, the evaluation electronics 102 is designed to ascertain a compensated temperature of the measurement material as a function of the first measurement value and the second measurement value.

FIG. 3 shows a cross section through another embodiment of the microwave sensor 100 according to the invention. The embodiment shown comprises the temperature sensor 1 according to the invention, which is arranged in, in particular screwed into, an opening provided for this purpose in the measuring tube 101. Also arranged in a respective opening in the measuring tube 101 are a transmitting antenna 116 for generating a microwave signal passing through the measurement material and a receiving antenna 118 for receiving the microwave signal passing through the measurement material. The temperature sensor 1, the transmitting antenna 116 and the receiving antenna 118 are arranged in a housing 120 which is designed to protect them from external influences. If the measurement material is conducted through the measuring tube 101 and if the temperature sensor 1 is in contact with the measurement material, a contribution by a current temperature of the measurement material predominates in the first measurement value ascertained with the first temperature probe. The temperature in the housing 120 also influences the first temperature value, but this contribution is significantly lower than the contribution of the measurement material. The second measurement value ascertained by means of the second temperature probe 112 is dominated by the current temperature in the housing 120. Especially with large temperature differences, the temperature of the measurement material also contributes noticeably, as it heats or cools the interior of the housing.

FIG. 4 shows a cross section through a magnetic-inductive flow meter 200 according to the invention. The structure and measuring principle of a magnetic-inductive flow meter 200 are known in principle. A flowable measurement material (or medium) having a sufficiently high electrical conductivity is conducted through a measuring tube 202. The measuring tube 202 comprises a carrier tube 203, which is typically made of, or at least comprises, steel, ceramic, plastic, or glass. To prevent the dissipation of the measurement voltage induced in the medium via the electrically conductive carrier tube 203, the inner wall is lined with an insulating material, such as a (plastic) liner 204 or ceramic tiles.

A magnetic-field-generating device 205 is arranged on the carrier tube 203 in such a way that the magnetic field lines are oriented substantially perpendicularly to a longitudinal direction defined by the measuring tube axis. The magnetic-field-generating device 205 generally comprises at least one saddle coil or at least one coil 213 with a coil core 214. In the embodiment shown in FIG. 4, the magnetic-inductive flow meter 200 has two diametrically arranged coils 213, each having a coil core 214 and a pole shoe. The two coil cores 214 are connected to one another, in particular magnetically, via a field return 222. The field return 222 connects the opposing sides of the coil cores 214 to each other. However, magnetic-inductive flow meters 200 with exactly one coil 213 having exactly one coil core 214 and without a field return 222 are also known. Furthermore, magnetic-inductive flow meters 200 having saddle coils in which no coil core is arranged are also known. The coil 213 is connected to an operating circuit 207 which operates the coil 213 by means of an operating signal. The operating signal can be a voltage with a time-variable curve and is characterized by operating signal parameters, wherein at least one of the operating signal parameters is controllable. The magnetic field generated by the magnetic-field-generating device 205 is generated by means of a pulsed direct current of alternating polarity provided by an operating circuit 207. This ensures a stable zero point and makes the measurement insensitive to influences due to electrochemical disturbances. The two coils 213 can be connected separately to the operating circuit 207 or connected in series or parallel to one another.

When the magnetic field is applied, a flow-dependent potential distribution results in the measuring tube 202, which potential distribution can be detected, for example, in the form of an induced measurement voltage. A device for tapping the induced measurement voltage is arranged on the measuring tube 2. In the embodiment shown, the device for tapping the induced measurement voltage is formed by two oppositely arranged measurement electrodes 217, 218, which establish a galvanic contact with the medium and are each arranged in respective electrode openings. However, magnetic-inductive flow meters 200 are also known which comprise measurement electrodes arranged on the outer wall of the carrier tube 203, that are not in contact with a measurement material. The measurement electrodes 217, 218 are generally arranged diametrically and form an electrode axis, or are intersected by a transverse axis which runs perpendicular to the magnetic field lines and the longitudinal axis of the measuring tube 202. However, devices intended for tapping off the induced measurement voltage and having more than two measurement electrodes are also known. The flow-rate-dependent measurement variable can be determined on the basis of the measured measurement voltage. The flow-rate-dependent measurement variable comprises the flow rate, the volumetric flow, and/or the mass flow of the medium. An evaluation electronics 207 is designed to detect the induced measurement voltage applied to the measurement electrodes 217, 218 and to ascertain the flow-rate-dependent measurement variable as a function of the measured measurement voltage. The measurement electrodes 217, 218 illustrated are shown only in simplified form. According to the invention, the evaluation electronics 207 is designed to ascertain a corrected temperature of the measurement material and/or a conductivity as a function of the first measurement value and the second measurement value.

Commercially available magnetic-inductive flow meters have two further electrodes in addition to the measurement electrodes 217, 218. In the first case, a fill level monitoring electrode optimally attached at the highest point of the measuring tube 202 serves to detect partial filling of the measuring tube 202 and is designed to pass this information to the user and/or to take into account the fill level when ascertaining the volumetric flow. Additionally, a reference electrode 233, which is usually attached diametrically to the fill level monitoring electrode or at the lowest point of the measuring tube cross section, serves to establish a controlled electric potential in the medium. Generally, the reference electrode 233 is used to connect the flowing medium to a ground potential.

According to the invention, the magnetic-inductive flow meter has a temperature sensor 1, which is arranged in a lateral opening in the peripheral surface of the measuring tube. In the embodiment shown, the temperature sensor 1 is arranged at least partially in the magnetic field-generating device 205 and additionally serves as a fill level monitoring electrode. Alternatively, the temperature sensor 1 can also be arranged offset from the magnetic-field-generating device 205 in the flow direction and from the measuring plane in which the measurement electrodes 217, 218 are located. Alternatively, the temperature sensor 1 can be designed as a measurement electrode or a reference electrode.

1-11. (canceled)

12. A temperature sensor for ascertaining a temperature of a measurement material, the temperature sensor includes a probe body comprising:
a measuring tip configured to be brought into contact with the measurement material;
a first probe receptacle extending into a front portion of the measuring tip;
a second probe receptacle located only in an end portion of the probe body;
a first temperature probe arranged in the first probe receptacle and configured to determine a first measurement value, wherein the first measurement value predominantly reflects a current temperature of the front portion; and
a second temperature probe arranged in the second probe receptacle and configured to determine a second measurement value, wherein the second measurement value predominantly reflects a current temperature of the end portion.

13. The temperature sensor according to claim 12, further comprising:
a sealing means receptacle configured to receive a sealing means,
wherein the sealing means receptacle is positioned between the front portion and end portion, and
wherein the second probe receptacle extends no further than the sealing means receptacle.

14. The temperature sensor according to claim 13, wherein the sealing means comprises a sealing ring.

15. The temperature sensor according to claim 12, further comprising:
a protective cap with four pins,
wherein two pins are electrically connected to the first temperature probe via a respective electrical conductor,
wherein two further pins are electrically connected to the second temperature probe via a respective electrical conductor.

16. The temperature sensor according to claim 12, further comprising:
a contact surface configured to serve as a stop, and
wherein the contact surface is positioned between the front portion and end portion, and
wherein the second probe receptacle extends no further than the contact surface.

17. The temperature sensor according to claim 12, wherein the probe body comprises metal.

18. The temperature sensor according to claim 12, wherein the measuring tip is at least partially conical.

19. The temperature sensor according to claim 12,
wherein the first probe receptacle and/or the second probe receptacle is at least partially filled with a thermal paste.

20. The temperature sensor according to claim 19, wherein the thermal paste comprises a silicone paste.

21. The temperature sensor according to claim 19, wherein the thermal paste comprises a silicone rubber.

22. A microwave sensor for determining a solid content of a solid in a flowable measurement material, the microwave sensor comprising:
a measuring tube configured to conduct the measurement material;
a transmitting antenna configured to generate a microwave signal passing through the measurement material;
a receiving antenna configured to receive the microwave signal passing through the measurement material;
a housing;
a first temperature probe configured to determine a first measurement value, wherein the first measurement value predominantly reflects a current temperature of the measurement material;
a second temperature probe configured to determine a second measurement value, wherein the second measurement value predominantly reflects a current temperature in the housing; and
an evaluation electronics configured to ascertain the solid content as a function of a provided propagation time and/or absorption of the received microwave signal, wherein the evaluation electronics is further configured to ascertain the solid content as a function of the first measurement value and the second measurement value.

23. The microwave sensor according to claim 22, wherein the measurement material is aqueous.

24. The microwave sensor according to claim 22,
wherein the first temperature probe and the second temperature probe are part of the temperature sensor according to claim 12.

25. The microwave sensor according to claim 22,
wherein the evaluation electronics is configured to ascertain a compensated temperature of the measurement material as a function of the first measurement value and the second measurement value.

26. A magnetic-inductive flow meter for ascertaining a flow-rate-dependent measurement variable of a flowable measurement material, comprising:
a measuring tube configured to conduct the measurement material;
a housing;
at least two measurement electrodes configured to ascertain a measurement voltage induced in the measurement material;
a magnetic-field-generating device configured to generate a magnetic field passing through the measuring tube;
the temperature sensor according to claim 12; and
evaluation electronics configured to ascertain a corrected temperature of the measurement material and/or a conductivity as a function of the first measurement value and the second measurement value.

27. The magnetic-inductive flow meter according to claim 26,
wherein the temperature sensor is arranged at least partially in the magnetic-field-generating device.

28. The magnetic-inductive flow meter according to claim 26,
wherein the temperature sensor is configured as a measurement electrode, a fill-level monitoring electrode, or a reference electrode.

29. The magnetic-inductive flow meter according to claim 26, wherein the measurement material is conductive.
